(19) United States
(12) Patent Application Publication
(10) Pub. No.: US 2009/0124312 A1
(43) Pub. Date: May 14, 2009

(54) Three-Card Baccarat Card Game

(76) Inventor: Ron M. Sarabi, Huntington Beach, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/937,465

(22) Filed: Nov. 8, 2007

(51) Int. Cl. A63F 13/00; A63F 1/00

(52) U.S. Cl. 463/12; 273/292; 463/25

(57) ABSTRACT

There is disclosed a method of playing a modified baccarat card game involving a dealer and a banker, who may be the same person or may be one or more computing devices, and at least one player. At least one player may make a wager on PLAYER, BANKER, or TIE. Three or more cards may be dealt to each of a PLAYER hand and a BANKER hand, one of the BANKER cards being dealt face down. The PLAYER hand may or may not receive a hit card depending on the value of the modulo ten sum of the original three or more cards dealt to the PLAYER hand and, in some circumstances, elections by each player individually.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to card games which are particularly suitable for use in gaming establishments.

2. Description of the Related Art

Baccarat is a gambling card game played for profit or enjoyment. There are three traditional variants of baccarat: baccarat chemin de fer, baccarat banque, and punto banco (or North American baccarat). Punto banco is strictly a game of chance, with no skill or strategy involved. Each player's moves are forced by the cards the player is dealt. In baccarat chemin de fer and baccarat banque, however, players can make choices, which makes baccarat chemin de fer and baccarat banque games of skill, at least in part.

Baccarat is a simple game with only three possible results—“PLAYER”, “BANKER” and “TIE”. The term “PLAYER” refers to one of two hands that are dealt, and does not refer to a customer or participant in the game. Similarly, the term “BANKER” refers to the second dealt hand, and does not refer to the house or the actual banker who settles wagers. A wager on PLAYER is a bet that the PLAYER hand will be superior to the BANKER hand. The method for evaluating hands will be explained subsequently. A wager on BANKER is a bet that the BANKER hand will be superior to the PLAYER hand. A wager on TIE is a bet that the two hands will have equal value. The participants may wager on any of the three results.

For clarity, within this description, the upper case word “PLAYER” will be used to refer to the dealt hand and the corresponding bet, and the lower case “player” will refer to any one of the participants in the game. Similarly, the upper case word “BANKER” will be used to refer to the dealt hand and the corresponding bet, and the lower case “banker” will refer to the party that settles the wagers with the players. For consistency, the upper case word “TIE” will refer to the wager that the PLAYER and BANKER hands will have the same value.

In each of the traditional baccarat variants, the PLAYER hand is dealt two cards face up and the BANKER hand is dealt one card face down and a second card face up. The PLAYER hand and the BANKER hand then may each receive a third card. In punto banco, whether or not the PLAYER hand and the BANKER hand receive a third card is dictated strictly by the rules of the game. In the other baccarat variants, the participants in the game may elect to receive or not receive a third card in some circumstances. Following common black-jack and baccarat terminology, electing to receive an additional card will be called “taking a hit”, and electing to not receive an additional card with be called “standing”.

In baccarat, cards 2-9 are worth face value, 10's and face cards (jack, queen, king) are worth zero, and aces are worth 1 point. The score of a hand is calculated by taking the sum of all cards modulo 10. Simply, when the total value of cards in a hand equals or exceeds 10, the tens digit is dropped. For example, a hand consisting of 2 and 3 is worth 5 (2+3=5). A hand consisting of 6 and 7 is worth 3 (6+7=13≡3)—the first digit is dropped because the total is higher than 10. A hand consisting of 4 and 6 is worth zero (4+6≡0). The highest score that can be achieved is 9.

Casinos and other gaming establishments continually offer new games to their clientele. Many popular games, including baccarat, enable each player to play against a banker, rather than against other players. In a casino, the banker, who may also function as the dealer, may be an employee playing on behalf of the establishment. Alternatively, in a “card room” game each player may have the option to act as banker, or the banker may be a licensed third-party service provider or the banker may be a player trust or pool fund. The card room establishment may provide a dealer to manage the game and collect fees from the players.

Players typically enjoy games which can be played rapidly and which offer players some degree of participation or require some degree of skill.

### DESCRIPTION OF THE DRAWINGS

FIG. 1 is a flow chart of a method of playing a card game.

FIG. 2 is a plan view of a table.

FIG. 3 is a block diagram of a computing device.

### DETAILED DESCRIPTION

Throughout this description, the embodiments and examples shown should be considered as exemplars, rather than limitations on the apparatus and methods disclosed or claimed.

Description of Processes

A modified baccarat card game may be played using one or more (commonly four, six, or eight) conventional 52-card decks of playing cards. The decks of cards may be modified by removing certain cards and/or adding additional cards. For example, the modified baccarat game may be played with a plurality of conventional decks with all 7's, 8's, 9's, and 10's removed from each deck and eight additional “face” cards or 10-valued cards added per deck.

One or more jokers may be added. For example, one Joker may be used when the game is played with four or six decks of playing cards and two jokers may be used if the game is played with eight decks of playing cards.

The game may be played by a dealer, a banker, and at least one additional player. The dealer and the banker may, in some circumstances, be the same person, or may be a computing device. One or more of the additional players may also be a computing device. The banker may be an employee of the casino or card club, a licensed third-party service provider, or one of the players participating in the game. The roll of the banker may rotate among the players, with each player being the banker for a fixed number of hands. The dealer may be the banker, or may be an employee of the casino or card club establishment who supervises the game and collects fees or commissions for the establishment.

The modified baccarat game can be played on any surface that allows the cards to be shuffled and dealt. A casino or card club may provide a specialized table having markings that define the player locations and the positions on the table for the players to place their bets and collections.

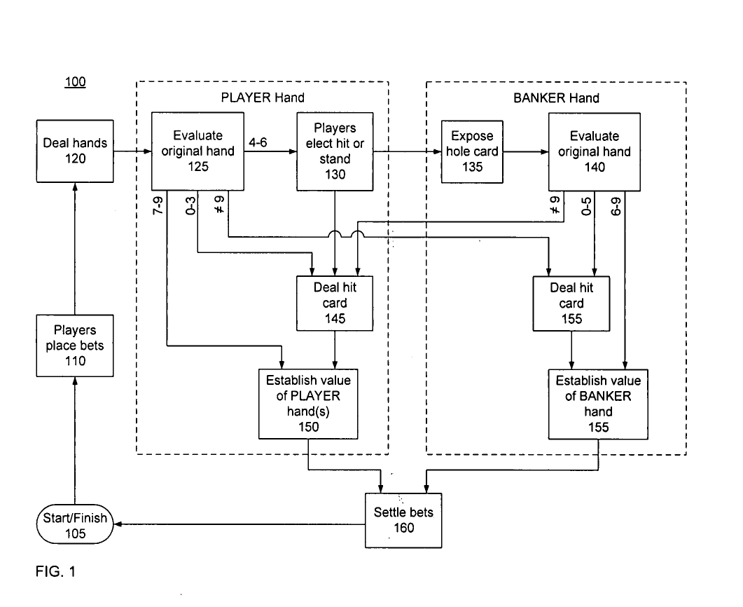

Referring now to FIG. 1, a flow chart of a method for playing a modified baccarat game begins and ends at 105. It must be understood that the process is cyclic. A completed hand may be followed by another hand, and this may occur in rapid succession.

At 110, each player may place a bet on either BANKER or PLAYER. Each player may also place a bet on TIE, either with or without a concurrent BANKER or PLAYER bet. After all bets are placed, at 120, the dealer may deal three or more cards to the PLAYER hand and three or more cards to the BANKER hand. The PLAYER hand and the BANKER hand may receive the same number of cards. The cards may be dealt alternately to the BANKER and PLAYER hands. The PLAYER cards may be dealt face up, and the BANKER cards may be dealt with one card face down, such that the value of the card is not apparent to the other players, and the other cards face up. The card dealt face down may be referred to as the “BANKER's hole card” or the “hole card”.

The PLAYER hand may be evaluated at 125 before the BANKER's hole card is exposed or turned face up. The PLAYER hand may be evaluated at 125 by calculating the sum, modulo ten, of the three or more dealt cards. A jack, queen, or king or other “face” card has a value of ten, which is equivalent to a value of zero. A joker, if used, may have any value from 0 to 9, and may be assigned the value that makes the hand value equal to nine.

The steps taken to complete the PLAYER hand may vary depending on the sum computed at 125. If the sum is within a first range, the PLAYER hand may be required, with one exception to be explained subsequently, to “take a hit”, or be dealt an additional card. If the sum is within a second range, the PLAYER hand may have to “stand” with that value. If the sum is within a third range, each player who has bet on PLAYER may have the option of taking a hit or standing. The first range may be 0-3, or some other range. The second range may be 7-9, or some other range. The third range may be 4-6, or some other range. If the value of the PLAYER hand calculated at 125 is in the third range, each player who made a bet on the PLAYER hand may elect, at 130, to take a hit or to stand. If at least one player takes the option of a hit, a hit card may be dealt.

Before the hit card is dealt to the PLAYER hand, the BANKER hole card may be exposed at 135, and the BANKER hand may be evaluated at 140. The BANKER hand may be evaluated by taking the sum, modulo ten, of the three or more dealt cards.

If the value of the original BANKER hand calculated at 140 is equal to nine, the PLAYER hand may be frozen and not allowed to take a hit. If the value of the BANKER hand calculated at 140 is not equal to nine, and the value of the PLAYER hand calculated at 125 was within the first range, a hit card may be dealt to the PLAYER hand at 145. If the value of the BANKER hand calculated at 140 is not equal to nine, and the value of the PLAYER hand calculated at 125 was within the third range, a hit card may be dealt to the PLAYER hand at 145 if at least one player with a bet on the PLAYER hand elected to take a hit.

The steps taken to complete the BANKER hand may be dictated by the rules of the modified baccarat game. If the value of the PLAYER hand calculated at 125 is equal to nine, the BANKER hand may be frozen and not allowed to take a hit. If the value of the PLAYER hand calculated at 125 is not equal to nine, and if the sum of the cards in the BANKER hand is within a fourth range, the BANKER hand may have to take a “hit”, or be dealt an additional card at 155. In this case, the value of the BANKER hand may be the modulo ten sum of all of the cards dealt to the BANKER hand, including the hit card. If the sum of the three or more original cards in the BANKER hand is within a fifth range, the BANKER hand may have to “stand” with that value. The fourth range may be 0-5 or some other range. The fifth range may be 6-9 or some other range.

The value, or score, of the PLAYER hand may be established at 150. If the sum calculated at 125 was in the first range, the value of the PLAYER hand is the modulo ten sum of all cards dealt to the PLAYER hand including the hit card. If the sum calculated at 135 was in the second range, a hit card was not dealt and the value of the PLAYER hand is the modulo ten sum of the original three or more cards dealt to the PLAYER hand. If the sum calculated at 135 was in the third range, the value of the PLAYER hand is either the modulo ten sum of the three or more cards initially dealt to the PLAYER hand for players who elected to not receive an additional card, or the modulo ten sum of all cards dealt to the PLAYER hand, including the hit card, for those players who elected to receive an additional card.

After the value of the PLAYER hand is established at 150, the value of the BANKER hand may be established at 155. The value of the BANKER hand may be established by taking the sum, modulo ten, of all of the cards dealt to the BANKER hand.

At 160, the bets may be settled. If the PLAYER hand has a higher value than the BANKER hand, bets on the PLAYER may be paid even money by the banker, and bets on the BANKER are won by the banker. If the BANKER hand has a higher value than the PLAYER hand, bets on the PLAYER may be won by the banker, and bets on the BANKER may be paid even money. If the BANKER and PLAYER hands have the same value, bets on the BANKER and the PLAYER may receive “no action” (the original bets are retained by the players), and bets on TIE may be paid at some odds, such as eight-to-one. In circumstances where the PLAYER hand received a hit card, only the three or more originally dealt cards are used to determine the results of TIE bets. To provide increased incentive for players to assume the banker roll, the banker may be allowed to win both BANKER and PLAYER bets in some circumstances, such as ties with a value of zero or one.

When the roll of banker is filled by one of the players, the player-banker may have a finite “stake”, or amount of money that he is willing or able to risk on any given hand. In this case, the banker's stake may be smaller than the total amount wagered by the other players participating in the game, and the banker may not be able to “cover”, or pay off, all of the bets made by the other players. To ensure fairness, the “action”, or settlement of wagers, may start with a different player on each hand and proceed in a predetermined order, such as clockwise, around the table until the accumulated total of the bets made equals or exceeds the banker's stake. Players whose bets are not covered by the dealer's stake receive “no action”, which is to say that they retain their original wager regardless of how they bet or the values of the hands.

The position on the table where the settlement of wagers begins may be designated by a marker, commonly called an “action button”. The position of the action button may move progressively around the table, or may be set randomly for each hand. For example, the dealer may roll dice at the start of each hand to determine the location of the action button for that hand, as in conventional baccarat. Alternatively, the position of the action button may be determined by the value of the BANKER hole card.

For example, the table where the modified baccarat game is played may have positions for eight players, one of whom may be acting as the player-banker. If the BANKER hole card is a joker or seven, the action button may be placed in front of the player to the player-banker's left. If the BANKER hole card is an ace or an eight, the action button may be placed in front of the second player to the player-banker's left. This process may be extended for the remaining cards such that the action button may be placed in front of the player to the player-banker's right if the hole card is a king or a six.

The modified baccarat game may proceed in a different sequence from that shown in the flow chart of FIG. 1. A different sequence may require that all bets are placed before the hands are dealt, that all bets are settled before the next hand begins, and that players make the hit/stand election (when the first sum is in the third range) before the BANKER hole card is exposed.

Description of Apparatus

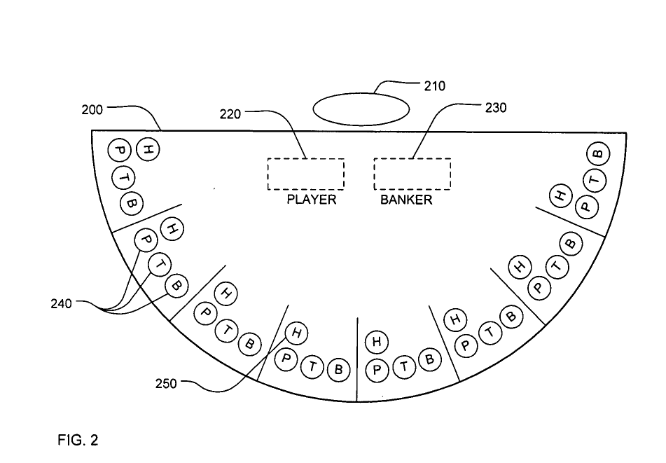

A modified baccarat game may be played at a table such as the exemplary table shown in FIG. 2. The table may be semicircular, as illustrated, or some other shape. The dealer 210 may be positioned at the mid-point of a flat side of the table or at some other location. The exemplary table shown in FIG. 2 can accommodate eight players in addition to the dealer. A table may accommodate more or fewer players. The players may be seated or standing. A banker, if required, may be in one of the player positions, such as immediately to the right of the dealer. The roll of banker may rotate among the players.

A table may have markings in front of the dealer's position to indicate where the cards constituting the PLAYER hand and the BANKER hand are to be placed. For example, the cards dealt to the PLAYER hand may be placed on the dealer's right-hand side, as indicated by the dashed box 220. The cards dealt to the BANKER hand may be placed on the dealer's left-hand side, as indicated by the dashed box 230. The table may having markings, not shown, to indicate which cards are the PLAYER hand and which cards are the BANKER hand. The table may have markings, not shown, to indicate the positions of the individual cards within each hand.

A table may be marked at each player's position to indicate where bets should be placed. The exemplary table 200 shown in FIG. 2 is marked with three “betting circles” 240 in front of each player. The circles may be marked “P”, “T”, and “B” or “PLAYER”, “TIE”, and “BANKER”, to indicate bets on PLAYER, TIE, or BANKER, respectively. The size of these circles is exaggerated in FIG. 2 for clarity. Other markings or shapes may be used to indicate where each player should place their bets. A table may also have markings to indicate if a player, having made a PLAYER bet, has elected to take a hit or stand if the original three or more PLAYER cards total 4, 5, or 6. For example, upon the player indicating a desire to take a hit, the player or the dealer may move the player's PLAYER bet from the circle labeled “P” to another position or marked location in front of the player. The exemplary table 200 has an additional circle 250, labeled “H”, adjacent to each “P” circle to indicate that a player elected to take a hit. A square, rectangle, line or other marking could also be used to indicate if the player elected to hit or stand.

In localities where the maximum bet, or limit, is set by regulation, the table 200 may include multiple sets of betting circles to allow players to make multiple wagers. The table may have, for example, three, six, or nine betting circles for each player position. In situations where a player plays multiple hands, those hands may be played “house way”, which is to say that the hands would be played by the dealer using the same rules applied to the BANKER hand.

Where periodic collections are made by the establishment, the table may also have markings, not shown in FIG. 2, indicating where each player should place the collection amount.

A modified baccarat game may also be played between one or more player and a computing device in the form of a gaming machine. In this case, the computing device may fulfill the roles of both dealer and banker.

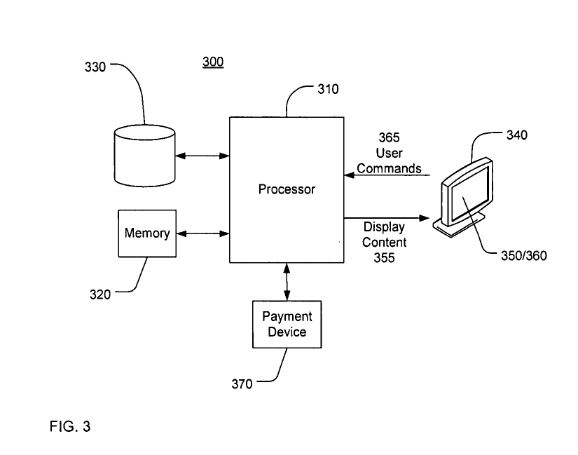

Referring now to FIG. 3, a computing device 300 may consist of a processor 310 and a memory 320 coupled to the processor 310. At least one storage device 330 may be coupled to the processor for the storage of data and instructions. As used herein, a storage device is a device that allows for reading and/or writing to a storage medium. These storage media include, for example, magnetic media such as hard disks, floppy disks and tape; optical media such as compact disks (CD-ROM and CD-RW) and digital versatile disks (DVD and DVD±RW); flash memory cards; and other storage media. Storage devices include hard disk drives, DVD drives, flash memory devices, and others.

Computing device 300 may include a user interface 340 that may be used by the one or more players to enter wagers and to elect to receive or not receive a hit card when appropriate. The user interface 340 may commonly be a display panel 350 with a touch-screen data entry device 360. The processor 310 may provide display content 355 to the display panel 350, and may receive user commands 365 from the touch-screen data entry device 360. The computing device 300 may include other user interface devices such as a keyboard, control panel, mouse or other pointing device, and other data entry devices.

Computing device 300 may include or be coupled to a payment device 370 for receiving bets and collections from the at least one player. The payment device may be a receptor for coins, bills, chips, or tokens; may be a financial card reader; or may be some other payment reception mechanism. Payment device 370 or some other device may be capable of providing payouts to the at least one player for winning hands. Payouts may be made in the form of cash, chips, tokens, credit against an account, script, or some other method.

Computing device 300 may perform the processes and steps attributed to the dealer and banker in the game described in FIG. 1. Computing device 300 may receive any bet and/or collection elected by the player. Computing device 300 may include software to simulate the random dealing of hands. The computing device 300 may receive an election to hit or stand from at least one player via the user interface 340. The computing device 300 may evaluate the hands and provide a payout to the player for a winning hand. The computing device 300 may allow a player to bet on more than one hand simultaneously. The player may play all hands. Alternately, the player may play only one hand and the computing device may play the additional hands on behalf of the player using predetermined rules.

Computing device 300 may include software and/or hardware for providing functionality and features described herein. Computing device 300 may therefore include one or more logic arrays, memories, analog circuits, digital circuits, software, firmware, and processors such as microprocessors, field programmable gate arrays (FPGAs), application specific integrated circuits (ASICs), programmable logic devices (PLDs) or programmable logic arrays (PLAs). The hardware and firmware components of the computing device 300 may include various specialized units, circuits, software and interfaces for providing the functionality and features described here. The processes, functionality and features may be embodied in whole or in part in software which operates on a client computer and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some components are performed by a client computer and others by other devices.

The processes and apparatus described herein may be implemented with any computing device. A computing device as used herein refers to any device with a processor, memory and a storage device that may execute instructions including, but not limited to, personal computers, server computers, computing tablets, video game systems, telephones, personal digital assistants (PDAs), portable computers, and laptop computers. These computing devices may run an operating system, including, for example, variations of the Linux, Unix, MS-DOS, Microsoft Windows, Palm OS, Solaris, Symbian, and Apple Mac OS X operating systems.

The computing device 300 may be implemented as hardware, software, firmware, or a combination thereof. Additional and fewer units, modules or other arrangement of software, hardware and data structures may be used to achieve the processes and apparatuses described herein.

Closing Comments

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A method of playing a card game involving a dealer and a banker, who may be the same person or may be one or more computing devices, and at least one player, the method comprising the steps of:
accepting one or more of a PLAYER wager, a BANKER wager, and a TIE wager from at least one player
dealing a PLAYER hand of at least three cards face up and a BANKER hand having the same number of cards as the PLAYER hand, the BANKER hand dealt with one card face down and the other cards face up
completing the PLAYER hand, completing the PLAYER hand comprising
calculating a first sum, modulo ten, of the values of the at least three cards in the PLAYER hand, with a face card having a value of zero
if the first sum falls within a first range, dealing an additional card to the PLAYER hand
if the first sum falls within a second range, not dealing an additional card to the PLAYER hand
if the first sum falls within a third range, accepting an election to receive or not receive an additional card from each player that placed a PLAYER wager, and dealing an additional card to the PLAYER hand if at least one player elects to receive the additional card.

2. The method of playing a card game of claim 1, wherein the first range is 0-3, the second range is 7-9, and the third range is 4-6.

3. The method of playing a card game of claim 1, further comprising establishing a value for the PLAYER hand, wherein
if the first sum falls within the first range, the value of the PLAYER hand is the sum, modulo 10, of all of the cards dealt to the PLAYER hand
if the first sum falls within the second range, the value of the PLAYER hand is the first sum
if the first sum falls within the third range
the value of the PLAYER hand is the first sum for players who elect to not receive an additional card and
the value of the PLAYER hand is the sum, modulo ten, of all of the cards dealt to the PLAYER hand for players who elect to receive the additional card.

4. The method of playing a card game of claim 3, further comprising
establishing a value for the BANKER hand, establishing a value for the BANKER hand comprising
turning the card dealt face down to the face up position
calculating a second sum, modulo ten, of the values of the at least three cards in the BANKER hand, with a face card having a value of zero
if the second sum falls within a fourth range, dealing an additional card to the BANKER hand, the value of the BANKER hand being the sum, modulo ten, of the all of the cards dealt to the BANKER hand
if the second sum falls within a fifth range, not dealing an additional card to the BANKER hand, the value of the BANKER hand being the second sum.

5. The method of playing a card game of claim 4, wherein the fourth range is 0-5 and the fifth range is 6-9.

6. The method of playing a card game of claim 4, further comprising settling the wagers accepted from the at least one player.

7. The method of playing a card game of claim 6, wherein settling the wagers comprises
if the value of the BANKER hand exceeds the value of the PLAYER hand, the banker winning PLAYER wagers and TIE wagers, and paying out on BANKER wagers
if the value of the PLAYER hand exceeds the value of the BANKER hand, the banker winning BANKER wagers and TIE wagers, and paying out on PLAYER wagers
if the value of the PLAYER hand equals the value of the BANKER hand, BANKER wagers and wagers PLAYER wagers receiving no action, and the banker paying out on TIE wagers at predetermined odds.

8. The method of playing a card game of claim 6, wherein settling the wagers comprises
if the value of the BANKER hand exceeds the value of the PLAYER hand, the banker winning PLAYER wagers and TIE wagers, and paying out on BANKER wagers
if the value of the PLAYER hand exceeds the value of the BANKER hand, the banker winning BANKER wagers and TIE wagers, and paying out on PLAYER
if the value of the PLAYER hand equals the value of the BANKER hand, BANKER wagers and wagers PLAYER wagers receiving no action, except the banker winning both PLAYER wagers and BANKER wagers for at least one value of the BANKER and PLAYER hands, and the banker paying out on TIE wagers at predetermined odds.

9. The method of playing a card game of claim 8, wherein the banker wins both BANKER wagers and PLAYER wagers if the PLAYER and BANKER hands have equal values of zero or one.

10. The method of playing a card game of claim 6, wherein
the banker begins the game with a predetermined stake
the settling of wagers begins with a randomly selected player and proceeds to each subsequent player in predetermined order until all wagers are settled or until the banker's stake will not cover any additional wagers.

11. The method of playing a card game of claim 10, wherein the settling of wagers begins with a player determined by the value of the BANKER hole card.

12. The method of playing a card game of claim 4, wherein
the BANKER hand is not eligible to receive an additional card if the first sum is equal to nine, and
the PLAYER hand is not eligible to receive an additional card if the second sum is equal to nine.

13. The method of playing a card game of claim 1, wherein
the game is played with plural decks of conventional playing cards,
all 7's, 8's, 9's and 10's are removed from each deck, and
eight additional face cards are added to each deck.

14. A computing device for playing a modified baccarat game, the computing device comprising:
a user input device
a display device
a processor
a memory
wherein the processor and the memory comprise circuits and software to perform actions comprising
accepting at least one of a PLAYER wager, a BANKER wager, and a TIE wager from a player
dealing a PLAYER hand of at least three cards face up and a BANKER hand having the same number of cards as the PLAYER hand, the BANKER hand dealt with one card face down and the other cards face up
completing the PLAYER hand, completing the PLAYER hand comprising
calculating a first sum, modulo ten, of the values of the at least three cards in the PLAYER hand, with a face card having a value of zero
if the first sum falls within a first range, dealing an additional card to the PLAYER hand
if the first sum falls within a second range, not dealing an additional card to the PLAYER hand
if the first sum falls within a third range, accepting an election to receive or not receive an additional card if the player placed a PLAYER wager, and dealing an additional card to the PLAYER hand if the player elects to receive the third card.

15. The computing device for playing a modified baccarat game of claim 14, wherein the first range is 0-3, the second range is 7-9, and the third range is 4-6.

16. The computing device for playing a modified baccarat game of claim 14, the actions performed further comprising establishing a value for the PLAYER hand, wherein
if the first sum falls within the first range, the value of the PLAYER hand is the sum, modulo 10, of all of the cards dealt to the PLAYER hand
if the first sum falls within the second range, the value of the PLAYER hand is the first sum
if the first sum falls within the third range
the value of the PLAYER hand is the first sum if the player elects to not receive an additional card and
the value of the PLAYER hand is the sum, modulo ten, of all of the cards dealt to the PLAYER hand if the player elects to receive an additional card.

17. The computing device for playing a modified baccarat game of claim 16, the actions performed further comprising establishing a value for the BANKER hand, establishing a value for the BANKER hand comprising
turning the card dealt face down to the face up position
calculating a second sum, modulo ten, of the values of the at least three cards in the BANKER hand, with a face card having a value of zero
if the second sum falls within a fourth range, dealing an additional card to the BANKER hand, the value of the BANKER hand being the sum, modulo ten, of all of the cards dealt to the BANKER hand
if the second sum falls within a fifth range, not dealing an additional card to the BANKER hand, the value of the BANKER hand being the second sum.

18. The computing device for playing a modified baccarat game of claim 17, wherein the fourth range is 0-5 and the fifth range is 6-9.

19. The computing device for playing a modified baccarat game of claim 17, the actions performed further comprising settling the wagers accepted from the player.

20. The computing device for playing a modified baccarat game of claim 19, wherein settling the wagers comprises
if the value of the BANKER hand exceeds the value of the PLAYER hand, the player losing a PLAYER wager or a TIE wager, and winning a BANKER wager
if the value of the PLAYER hand exceeds the value of the BANKER hand, the player losing a BANKER wager or a TIE wager, and winning a PLAYER wager
if the value of the PLAYER hand equals the value of the BANKER hand, BANKER wagers and wagers PLAYER wagers receiving no action, and the player winning on a TIE wager at predetermined odds.

21. The computing device for playing a modified baccarat game of claim 19, wherein settling the wagers comprises
if the value of the BANKER hand exceeds the value of the PLAYER hand, the player losing a PLAYER wager or a TIE wager, and winning a BANKER wager
if the value of the PLAYER hand exceeds the value of the BANKER hand, the player losing a BANKER wager or a TIE wager, and winning a PLAYER wager
if the value of the PLAYER hand equals the value of the BANKER hand, BANKER wagers and PLAYER wagers receiving no action, except the player losing either a PLAYER wager or a BANKER wager for at least one value of the BANKER and PLAYER hands, and the player winning a TIE wager at predetermined odds.

22. The computing device for playing a modified baccarat game of claim 21, the player losing both a BANKER wager and a PLAYER wager if the PLAYER and BANKER hands have equal values of zero or one.

23. The computing device for playing a modified baccarat game of claim 17, wherein
the BANKER hand is not eligible to receive an additional card if the first sum is equal to nine, and
the PLAYER hand is not eligible to receive an additional card if the second sum is equal to nine.

24. The computing device for playing a modified baccarat game of claim 14, wherein
the computing device simulates playing the game with plural decks of conventional playing cards with all 7's, 8's, 9's and 10's removed from each deck and eight additional face cards added to each deck.

25. A method of playing baccarat, comprising:
providing a dealer and a banker, who may be the same person or may be one or more computing devices
accepting one or more of a PLAYER wager, a BANKER wager, and a TIE wager from at least one player
dealing a PLAYER hand of three cards face up and a BANKER hand of two cards face up and one card face down
if the modulo ten sum of the PLAYER hand is from 4 to 6, allowing each player having made a PLAYER wager to elect to receive a fourth card or to not receive a fourth card for the PLAYER hand
turning the card dealt face down to a face up position
if the modulo ten sum of the BANKER hand is not equal to nine and the modulo ten sum of the PLAYER hand is from 0 to 3, dealing a fourth card to the PLAYER hand
if the modulo ten sum of the BANKER hand is not equal to nine and the modulo ten sum of the PLAYER hand is from 4 to 6, dealing a fourth card to the PLAYER hand if any playing have made a PLAYER bet elected to receive a fourth card
if the modulo ten sum of the PLAYER hand is not equal to nine and if the modulo ten sum of the BANKER hand is hand is from 0 to 5, dealing a fourth card to the BANKER hand
settling wagers according to a predetermined set of rules.
